(19) United States
(12) Patent Application Publication
(10) Pub. No.: US 2024/0367016 A1
(43) Pub. Date: Nov. 7, 2024

(54) Core Apparatus for Manufacturing Straight and Bent Graphite Golf-Club Shafts

(71) Applicant: DJ Golf Engineering Inc., Nashville, TN (US)

(72) Inventor: David Kelly, Nashville, TN (US)

(21) Appl. No.: 18/310,903

(22) Filed: May 2, 2023

(51) Int. Cl. A63B 53/10; B29D 23/00

(52) U.S. Cl. CPC A63B 53/10; B29D 23/00; A63B 53/007; A63B 2209/02

(57) ABSTRACT

A bendable core insert configured for manufacturing a golf-club shaft. The bendable core includes a bendable relief tube having a first end attached to a top coupling tube and a second end attached to a bottom coupling tube. The bendable relief tube, the top coupling tube, and the bottom coupling tube have respective channels that are aligned to form a continuous channel through opposing ends of the bendable core insert. The length of the bendable core insert corresponds to a length of a corresponding segment of the golf-club shaft. The bendable relief tube is configured to be bent in one or more directions to define a bend profile of the corresponding segment of the golf-club shaft.

### TECHNICAL FIELD

This application relates generally to golf clubs.

### BACKGROUND

Golf-club shafts are manufactured in round, cylindrical, and concentric shapes (of varying singular or multi-material compositions) the specifications of which are governed by certain rules and governing organizations. Golf shafts are one of three principal components which make up the basis of a golf club—a golf-club head, the golf-club shaft, and a grip. Golf-club shafts have differing utilities which are dependent on the type and form of each club they are a component or part of. Generally, it is the intended usage of each of these implements that drives and determines each of the golf club variants.

More specifically, a putter is a golf club used for striking the golf ball with relative precision and using a generally low-force stroke/blow to the golf ball. Recent design variations and exceptions to the rules of golf have incorporated different geometries for the shaft portion of the putter club. Recently, bends in the shaft portion of the putter club have been incorporated in metallic shafts. Such mechanical bending is possible due to mechanical manipulation and the malleability of the metallic-shaft materials. The bends can be in multiple axis at specific positions along the length of the shaft.

Recent innovations in non-metallic, polymer- and/or carbon-based materials have been incorporated into golf-club shafts. Golf-club shafts formed of these new materials are limited to straight shafts. There is no existing manufacturing method to create bent shafts that include these new non-metallic, polymer- and/or carbon-based materials.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages and novel features of the disclosure will be set forth in the following detailed description of the disclosure when considered in conjunction with the drawings, which are intended to illustrate, not limit, the invention.

An aspect of the invention is directed to a bendable core insert configured for manufacturing a golf-club shaft. The bendable core insert comprises a bendable relief tube having opposing first and second relief-tube ends, an inner relief-tube diameter that defines a relief-tube channel that extends along a length of the relief tube, and an outer relief-tube diameter. The bendable core insert further comprises a first coupling tube having a first end attached to the first relief-tube end, the first coupling tube having an inner first-coupling-tube diameter that defines a first-coupling-tube channel that extends along a length of the first coupling tube, and an outer first-coupling-tube diameter. The bendable core insert further comprises a second coupling tube having a first end attached to the second relief-tube end, the second coupling tube having an inner second-coupling-tube diameter that defines a second-coupling-tube channel that extends along a length of the second coupling tube, and an outer second-coupling-tube diameter. The relief-tube channel, the first-coupling-tube channel, and the second-coupling-tube channel are aligned to form a continuous channel that extends though opposing ends of the bendable core insert. A length of the bendable core insert corresponds to a length of a corresponding segment of the golf-club shaft. The bendable relief tube is configured to be bent in one or more directions to define a bend profile of the corresponding segment of the golf-club shaft.

In one or more embodiments, the outer first-coupling-tube diameter and the outer second-coupling-tube diameter are larger than the outer relief-tube diameter. In one or more embodiments, the bendable relief tube is configured to be bent with respect to a first plane defined by first and second axes, with respect to a second plane defined by the second axis and a third axis, and with respect to a third plane defined by the first and third axes, and the first, second, and third axes are mutually orthogonal.

In one or more embodiments, the first coupling tube is configured to be releasably attached to a mandrel that corresponds to a straight segment of the golf-club shaft.

In one or more embodiments, the bendable core insert is coated with a polymer material along a length of the bendable core insert, the polymer material having a thickness that defines an outer diameter of the bendable core insert, the outer diameter of the bendable core insert corresponding to an inner diameter of the corresponding segment of the golf-club shaft. In one or more embodiments, the outer diameter of the bendable core insert is variable with respect to a length of the bendable core insert such that the inner diameter of the corresponding segment of the golf-club shaft is variable.

Another aspect of the invention is directed to an assembly for manufacturing a golf-club shaft. The assembly includes a polymer-coated material bendable core insert wherein the corresponding segment is a first of the golf-club shaft. The assembly further includes a mandrel releasably attached to the first coupling tube. A length of the bendable core insert corresponds to a length of the first segment of the golf-club shaft. A length of the mandrel corresponds to a length of the second segment of the golf-club shaft. The bendable relief tube is configured to be bent in one or more directions to define a bend profile of the first segment of the golf-club shaft.

In one or more embodiments, a diameter of the mandrel corresponds to an inner diameter of the second segment of the golf-club shaft. In one or more embodiments, the bendable relief tube is configured to be bent with respect to a first plane defined by first and second axes, with respect to a second plane defined by the second axis and a third axis, and with respect to a third plane defined by the first and third axes. The first, second, and third axes are mutually orthogonal.

Another aspect of the invention is directed to a method of manufacturing a golf-club shaft. The method comprises coating a bendable core insert with a polymer material, the bendable core insert comprising a bendable relief tube having opposing first and second relief-tube ends, an inner relief-tube diameter that defines a relief-tube channel that extends along a length of the relief tube, and an outer relief-tube diameter. The bendable core insert further comprises a first coupling tube having a first end attached to the first relief-tube end, the first coupling tube having an inner first-coupling-tube diameter that defines a first-coupling-tube channel that extends along a length of the first coupling tube, and an outer first-coupling-tube diameter. The bendable core insert further comprises a second coupling tube having a first end attached to the second relief-tube end, the second coupling tube having an inner second-coupling-tube diameter that defines a second-coupling-tube channel that extends along a length of the second coupling tube, and an outer second-coupling-tube diameter. The relief-tube channel, the first-coupling-tube channel, and the second-coupling-tube channel are aligned to form a continuous channel that extends though opposing ends of the bendable core insert. A length of the bendable core insert corresponds to a length of a first segment of the golf-club shaft. The method further comprises bending the bendable relief tube in one or more directions to define a bend profile of the first segment of the golf-club shaft; coating the bendable core insert with a first polymer material along a length of the bendable core insert, the first polymer material having a thickness that defines an outer diameter of the bendable core insert, the outer diameter of the bendable core insert corresponding to an inner diameter of the first segment of the golf-club shaft; attaching a removable mandrel to a second end of the first coupling tube to form a shaft insert assembly. The removable mandrel has a length that corresponds to a length of a second segment of the golf-club shaft, and a diameter that corresponds to an inner diameter of the second segment of the golf-club shaft. The method further comprises covering the shaft insert assembly with a shaft material that includes a composite material and/or a second polymer material to form a covered shaft insert assembly; curing the covered shaft insert assembly; and after curing, removing the removable mandrel from the second end of the first coupling tube to form the golf-club shaft, the golf-club shaft including the bendable core insert.

In one or more embodiments, the second segment of the golf-club shaft comprises a tube formed by the shaft material. In one or more embodiments, the shaft material conforms to one or more bends in the bendable relief tube to form the bend profile in the first segment of the golf-club shaft. In one or more embodiments, the one or more bends include: a first bend with respect to a first plane defined by first and second axes, and a second bend to a second plane defined by the second axis and a third axis, wherein the first, second, and third axes are mutually orthogonal. In one or more embodiments, the one or more bends include a third bend with respect to a third plane defined by first and third axes.

Another aspect of the invention is directed to a golf-club shaft comprising a shaft tube formed of a shaft material that includes a composite material and/or a polymer material, the tube having a channel and first and second sections; and a polymer-coated core insert in the channel of the first section, the polymer-coated core insert extending along a length of the first segment, wherein the second section is hollow.

In one or more embodiments, the polymer-coated core insert comprises a relief tube; a first coupling tube having a first end attached to a first relief-tube end; a second coupling tube having a first end attached to a second relief-tube end; and a polymer material coating the bendable core insert along a length of the core insert, the polymer material having a thickness that defines an outer diameter of the bendable core insert, the outer diameter of the bendable core insert defining an inner diameter of the first section of the golf-club shaft. In one or more embodiments, the relief tube is bent in one or more directions, and the first section has a bend profile that conforms to one or more bends in the relief tube.

In one or more embodiments, the second coupling tube has a second end that is configured to be attached to a golf-club head. In one or more embodiments, the shaft material includes the composite material, the composite material comprising graphite, graphene, fiberglass, and/or carbon fiber.

Another aspect of the invention is directed to a golf-club shaft; and a golf-club head attached to the first section of the shaft tube.

Another aspect of the invention is directed to a kit for manufacturing a golf-club shaft, comprising: a bendable relief tube having opposing first and second relief-tube ends, an inner relief-tube diameter that defines a relief-tube channel that extends along a length of the relief tube, and an outer relief-tube diameter. The kit further comprises a first coupling tube having a first end configured to be attached to the first relief-tube end, the first coupling tube having an inner first-coupling-tube diameter that defines a first-coupling-tube channel that extends along a length of the first coupling tube, and an outer first-coupling-tube diameter. The kit further comprises a second coupling tube having a first end configured to be attached to the second relief-tube end, the second coupling tube having an inner second-coupling-tube diameter that defines a second-coupling-tube channel that extends along a length of the second coupling tube, and an outer second-coupling-tube diameter. The kit further comprises a mandrel releasably attached to the first coupling tube. When the first coupling tube is attached to the first relief the first relief-tube end and the second coupling tube is attached to the second relief-tube end, the relief-tube channel, the first-coupling-tube channel, and the second-coupling-tube channel configured to be aligned to form a continuous channel.

In one or more embodiments, the first coupling tube is attached to the first relief the first relief-tube end and the second coupling tube is attached to the second relief-tube end to form an assembled bendable core insert, the continuous channel extends though opposing ends of the assembled bendable core insert, a length of the assembled bendable core insert corresponds to a length of a corresponding segment of the golf-club shaft, and the assembled bendable relief tube is configured to be bent in one or more directions to define a bend profile of the corresponding segment of the golf-club shaft.

### BRIEF DESCRIPTION OF THE DRAWINGS

For a fuller understanding of the nature and advantages of the concepts disclosed herein, reference is made to the detailed description of preferred embodiments and the accompanying drawings.

FIG. 1 is a top view of a bendable core apparatus configured for manufacturing a golf-club shaft according to an embodiment.

FIG. 2 is a top view of a bendable relief tube in a bent state according to an embodiment.

FIG. 3 is a flow chart of a method for manufacturing a golf-club shaft according to an embodiment.

FIG. 4 is a top view of a polymer-coated bendable core apparatus, according to an embodiment, that can be formed in using the flow chart illustrated in FIG. 3.

FIG. 5 is a top view of a polymer-coated bendable core apparatus, according to another embodiment, that can be formed in using the flow chart illustrated in FIG. 3.

FIGS. 6A and 6B are isometric and cross-sectional views, respectively, of a mold for bending a polymer-coated bendable core apparatus according to an embodiment.

FIG. 7 is a top view of a bent polymer-coated core apparatus according to an embodiment.

FIG. 8 is a top view of a removable mandrel according to an embodiment.

FIG. 9 is a top view of a shaft insert assembly according to an embodiment.

FIG. 10 is a top view of shaft material covering the shaft insert assembly illustrated in FIG. 9 according to an embodiment.

FIG. 11 is a top view of a golf-club shaft formed according to the flow chart illustrated in FIG. 3 according to an embodiment.

FIG. 12 is a top view of a golf-club shaft formed according to the flow chart illustrated in FIG. 3 according to another embodiment.

FIG. 13 is top view of a golf club that includes the golf-club shaft illustrated in FIG. 11.

FIG. 14 is top view of a golf club that includes the golf-club shaft illustrated in FIG. 12.

FIG. 15 is a block diagram of a kit for manufacturing a golf-club shaft according to an embodiment.

FIG. 16 is a block diagram of a kit for manufacturing a golf-club shaft according to another embodiment.

### DETAILED DESCRIPTION

The shaft profile design provides specific functionality in conjunction with the overall design of each specific kind of putter (or other golf club). The shaft does several things to enhance the “playability” and performance of the putter golf club. Specifically, the shaft is the connection vehicle for the club delivering the club head to the ball during a golf stroke. The shaft characteristics determine the way the club contacts the ball during the stroke and is responsible for the transmission of vibration to the hands—otherwise known as the “feel” of the putter club. Graphite shafts are an enhanced product that, because of their mechanical properties, absorb the shock of impact as opposed to transmitting the same vibration. It is this feature that makes graphite construction the more desirable of materials from which to construct a golf putter shaft.

Limitations in golf shaft manufacturing have prevented the supply of graphite shafts in geometries other that a straight shaft profile. A percentage of putter designs use a shaft other than a straight shaft. This “bent shaft” design accomplishes a similar function as a working golf club putter but does so in differing head designs and methods of attachment between the shaft and the putter club head. Previously, these attachment methods were not feasible in graphite or composite materials due to the lack of a viable shaft design/product in the marketplace.

Manufacturing a golf-club shaft with bend profiles using non-metallic, polymer- and/or carbon-based materials presents technical problems because the current method of production involves the “rolling” of carbon-infused fabric in sheet or partial sheet form on a retractable/removable cylindrical/tapered mandrel. The mandrel mirrors the internal structure of the golf-club shaft and according to the rules of golf must be of a specific concentricity (e.g., the internal shape and wall thickness of the tube is concentric throughout).

Typically, the forming mandrel is removed from the inside of the formed shaft once the materials have been thermo-chemically hardened. Any bends in the golf-club shaft creates a problem in removing the mandrel from a fully formed (cured) finished shaft because neither the cured material nor the forming mandrel is pliable or flexible enough to allow for extraction. The forming mandrel is not pliable for quality-control purposes. If the forming mandrel were pliable, then the internal features of the manufactured product would be extremely inconsistent and prone to abnormal levels of quality rejections, making the economics of production unattractive to any manufacturer.

To overcome these and/or other deficiencies, a bendable core apparatus is used to manufacture a golf-club shaft that can include one or more bends. The bendable core apparatus includes a bendable relief tube, a top tube coupling, and a bottom tube coupling. The bendable relief tube can be covered with a polymer material and can be bent in one or more directions to define a bend profile of the golf-club shaft. The bendable relief tube is releasably attached to a mandrel to form a shaft insert assembly. The shaft material(s) (e.g., composite material and/or a polymer material) is/are applied to external surface of the shaft insert assembly and then cured. After the shaft material(s) are hardened (cured), the mandrel is removed to form a golf-club shaft. The bendable core apparatus is not removed and remains in the golf-club shaft.

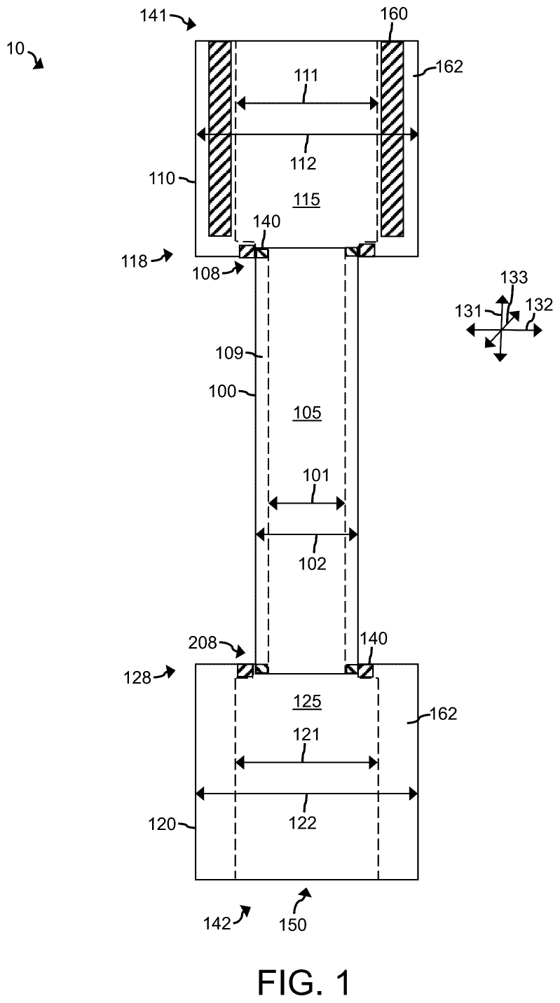

FIG. 1 is a top view of a bendable core apparatus 10 configured for manufacturing a golf-club shaft according to an embodiment. The apparatus 10 includes a bendable relief tube 100, a top tube coupling 110, and a bottom tube coupling 120. The apparatus 10 is illustrated in an assembled state.

The bendable relief tube 100 has a length that can be measured with respect to a first axis 131 and inner and outer diameters 101, 102, respectively, that can be measured with respect to a second axis 132 and/or with respect to a third axis 133. Axes 131-133 are mutually orthogonal. The inner diameter 101 of the relief tube 100 defines a relief-tube channel 105 that extends through opposing ends 108, 208 of the relief tube 100. The relief tube 100 has a relief-tube wall 109 that has a thickness defined by the difference between the outer and inner diameters 102, 101.

The bendable relief tube 100 can comprise one or more metals, polymers, plastics, carbon-based materials, and/or other bendable materials. Example metals can include aluminum, stainless steel, titanium, copper, brass, and/or iron. Example plastics and/or polymers can include polyethylene, polyvinyl chloride (PVC) polypropylene, polyurethane, and/or poly(methyl methacrylate). Example carbon-based materials can include graphite, graphite sheet, graphene, nanotube graphite fibers, carbon-derivative fibers, fiberglass (e.g., sheet, mat, or blown) all of which may be molded, compression molded, extruded, or gaseous blown into a desired form/shape.

The bendable relief tube 100 can be bent in one or more directions and/or with respect to one or more planes. For example, the bendable relief tube 100 can be bent with respect to a first plane defined by the first and second axes 131, 132, with respect to a second plane defined by the second and third axes 132, 133, and/or with respect to a third plane defined by the first and third axes 131, 133. The bendable relief tube 100 can be bent at one or more locations along the length of the bendable relief tube 100. The bendable relief tube 100 is illustrated in a straight or an unbent state.

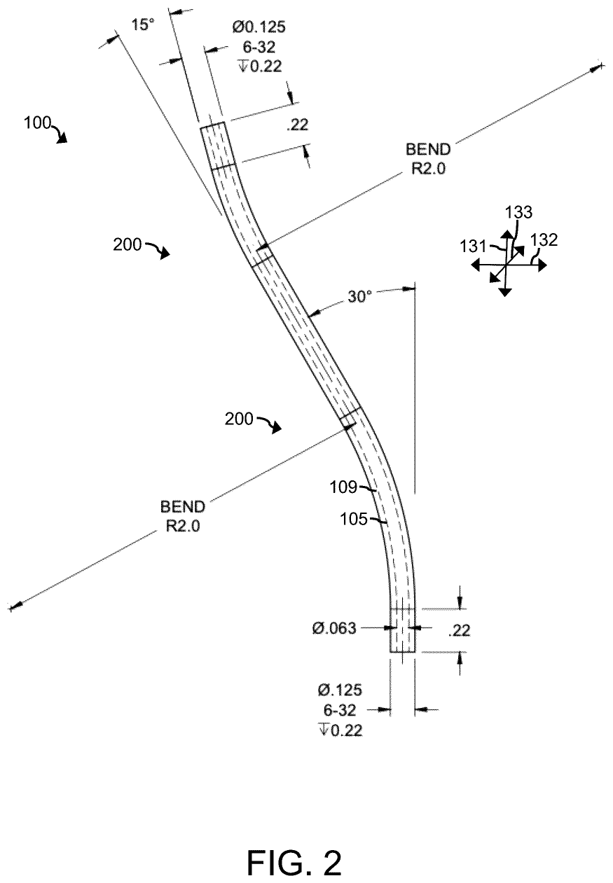

An example of a bendable relief tube 100 in a bent state is illustrated in FIG. 2. The bends 200 in the bendable relief tube 100 are with respect to the first plane, which is defined by the first and second axes 131, 132. The bendable relief tube 100 can include similar bends with respect to the second plane and/or with respect to the third plane, which are not illustrated for brevity. The dimensions illustrated in FIG. 2 provided as an example and are not intended to be limiting. The bends in the bendable relief tube 100, including bends 200, represent a bend profile of the golf shaft to be manufactured using the bendable core apparatus 10.

The inner diameter 101 of the bendable relief tube 100 can be about 0.15 inches to about 0.25 inches including about 0.2 inches and any value or range between any two of the foregoing dimensions. In another example, the inner diameter 101 can be larger than about 0.25 inches or smaller than about 0.15 inches. As used herein, “about” means plus or minus 10% of the relevant value.

The outer diameter 102 of the bendable relief tube 100 can be about 0.2 inches to about 0.3 inches including about 0.25 inches and any value or range between any two of the foregoing dimensions. In another example, the outer diameter 102 can be larger than about 0.3 inches or smaller than about 0.2 inches.

The length of the bendable relief tube 100 can be about 2.5 inches to about 3.5 inches including about 2.75 inches, about 3 inches, about 3.25 inches, and any value or range between any two of the foregoing dimensions. In another example, the length of the bendable relief tube 100 can be larger than about 3.5 inches or smaller than about 2.5 inches.

Returning to FIG. 1, the top and bottom tube couplings 110, 120 are attached at respective ends 108, 208 of the bendable relief tube 100. In an embodiment, a first end 118 of the top tube coupling 110 and a first end 108 of the bendable relief tube 100 can be mechanically coupled via complementary threaded couplings 140 defined in the first end 108 of the bendable relief tube 100 and in the first end 118 of the top tube coupling 110. For example, the threaded couplings 140 in the first end 108 of the bendable relief tube 100 can have female threads and the threaded couplings 140 in the first end 118 of the top tube coupling 110 can have male threads (or vice versa).

Similarly, a first end 128 of the bottom tube coupling 120 and a second end 208 of the bendable relief tube 100 can be mechanically coupled via complementary threaded couplings 140 defined in the second end 208 of the bendable relief tube 100 and in the first end 128 of the bottom tube coupling 120. For example, the threaded couplings 140 in the second end 208 of the bendable relief tube 100 can have male threads and the threaded couplings 140 in the first end 128 of the bottom tube coupling 120 can have female threads (or vice versa).

In another embodiment, the top and bottom tube couplings 110, 120 are attached at respective ends 108, 208 of the bendable relief tube 100 using an adhesive. In another embodiment, the top and bottom tube couplings 110, 120 are attached at respective ends 108, 208 of the bendable relief tube 100 via friction fit. In another embodiment, the top and bottom tube couplings 110, 120 are attached at respective ends 108, 208 of the bendable relief tube 100 via bolts and/or screws. Combinations of any of the foregoing can be used. The top tube coupling 110 can be attached to bendable relief tube 100 in the same or different manner as the bottom tube coupling 110 and the bendable relief tube 100.

The top and bottom tube couplings 110, 120 have a respective length that can be measured with respect to the first axis 131, a respective inner diameter 111, 121, and a respective outer diameter 112, 122. The inner diameters 111, 121 and the outer diameters 112, 122 can be measured with respect to the second axis 132 and/or with respect to the third axis 133. The inner diameters 111, 121 of the top and bottom tube couplings 110, 120 define respective top and bottom channels 115, 125. Each channel 115, 125 extends through respective opposing ends 118, 128 of the respective top and bottom tube couplings 110, 120.

The inner diameter 111 of the top tube coupling 110 can have the same or different dimensions as the inner diameter 121 of the bottom tube coupling 120. In one example, the inner diameter 111 is about 0.2 inches to about 0.4 inches, including about 0.25 inches, about 0.3 inches, about 0.35 inches, and any value or range between any two of the foregoing dimensions. In another example, the inner diameter 111 can be larger than about 0.4 inches or smaller than about 0.2 inches. In one example, the inner diameter 121 is about 0.15 inches to about 0.3 inches, including about 0.2 inches, about 0.25 inches, and any value or range between any two of the foregoing dimensions. In another example, the inner diameter 121 can be larger than about 0.3 inches or smaller than about 0.15 inches. The inner diameters 111, 121 of the top and bottom tube couplings 110, 120, respectively, are preferably larger than the inner diameter 101 of the bendable relief tube 100.

The outer diameter 112 of the top tube coupling 110 can have the same or different dimensions as the outer diameter 122 of the bottom tube coupling 120. Each outer diameter 112, 122 can be about 0.2 inches to about 0.4 inches, including about 0.25 inches, about 0.3 inches, about 0.35 inches, and any value or range between any two of the foregoing dimensions. In another example, the outer diameter 112 can be larger than about 0.4 inches or smaller than about 0.2 inches. The outer diameters 112, 122 of the top and bottom tube couplings 110, 120, respectively, are larger than the outer diameter 102 bendable relief tube 100.

The length of the top tube coupling 110 can be about 1.25 inches to about 1.75 inches including about 1.5 inches and any value or range between any two of the foregoing dimensions. In another example, length of the top tube coupling 110 can be larger than about 1.75 inches or smaller than about 1.25 inches. The length of the bottom tube coupling 120 can be about 1 inch to about 1.5 inches including about 1.25 inches and any value or range between any two of the foregoing dimensions. In another example, length of the bottom tube coupling 120 can be larger than about 1.5 inches or smaller than about 1 inch. The lengths of the top and bottom tube couplings 110, 120 are preferably larger than the length of the bendable relief tube 100.

The top and bottom channels 115, 125 and the relief-tube channel 105 form a continuous channel 150 that extends through opposing ends 141, 142 of the bendable core apparatus 10. The continuous channel 150 can allow trapped gasses including air to escape during manufacturing of the golf-club shaft and/or of the golf club. For example, air needs to escape when attaching a golf-club shaft to a golf-club head to form a golf club. The continuous channel 150 can function as a vent hole for the bendable core apparatus 10.

The top and bottom tube couplings 110, 120 can comprise one or more metals, plastics, polymers, ferrous materials, non-ferrous materials, and/or other materials. Example metals can include aluminum, titanium, stainless steel, copper, brass, and/or iron. Example plastics and/or polymers can include polyethylene, polyvinyl chloride (PVC) polypropylene, polyurethane, and/or poly(methyl methacrylate) (PMMA). Example ferrous materials include iron and iron alloys such as steel, carbon steel, and/or stainless steel. Example non-ferrous materials include copper, aluminum, and/or brass. The top and bottom tube couplings 110, 120 can comprise the same or different materials. In addition, the top and/or bottom tube couplings 110, 120 can comprise the same or different materials as the bendable relief tube 100.

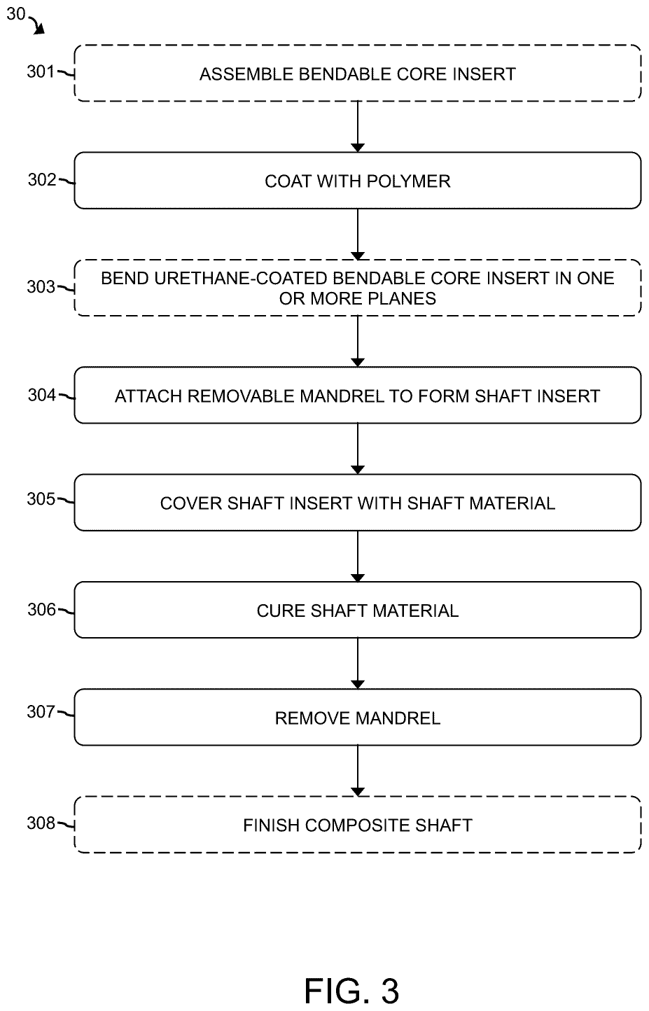

FIG. 3 is a flow chart of a method 30 for manufacturing a golf-club shaft according to an embodiment.

The bendable core apparatus 10 is used in method 30. If it is not already assembled, the bendable core apparatus 10 is assembled in optional step 301. In optional step 301, the top and bottom tube couplings 110, 120 are attached to opposing ends 108, 208 of the bendable relief tube 100. The top and bottom tube couplings 110, 120 and the bendable relief tube 100 can be attached via threaded couplings 140, an adhesive, fasteners, and/or another attachment means.

In step 302, the assembled bendable core apparatus 10 is coated with a polymer such as polyurethane, nylon, and/or another poured/cast polymer material. The thickness of the polymer coating can vary such to provide a polymer-coated bendable core apparatus that has uniform or substantially uniform diameter (e.g., less than or equal to a 5% variation in thickness) over the length of the polymer-coated bendable core apparatus.

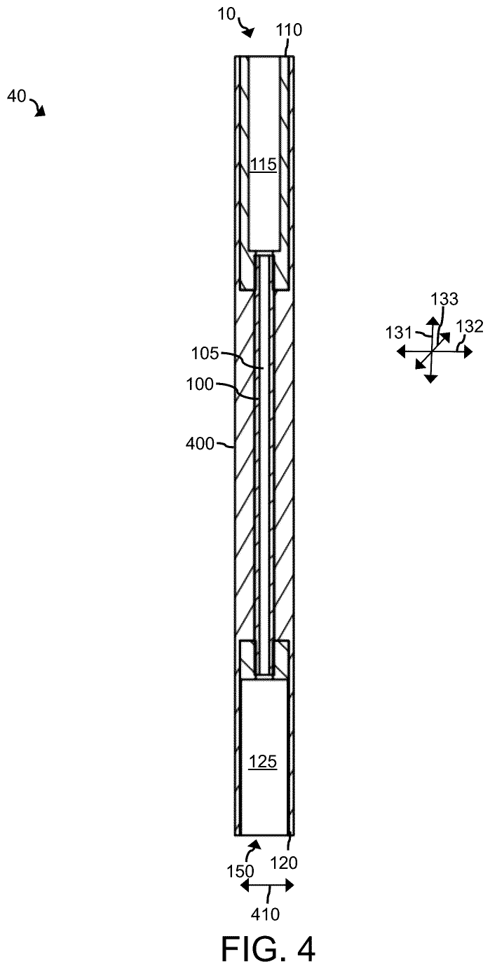

FIG. 4 illustrates an example of a polymer-coated bendable core apparatus 40 that can be formed in step 302. The polymer-coated bendable core apparatus 40 is shown as partially transparent for discussion purposes only.

A polymer layer 400 is applied to the outer/external surface of the bendable core apparatus 10. For example, the polymer layer 400 is applied along the length and circumference of the top and bottom tube couplings 110, 120 and of the bendable relief tube 100. The polymer layer 400 does not obstruct the top and bottom channels 115, 125 such that the continuous channel 150 remains open through the bendable core apparatus 10. The polymer layer 400 can comprise or consist of polyurethane or another polymer.

The thickness of the polymer coating 400 can be measured with respect to the second and/or third axes 132, 133. The thickness of the polymer coating 400 can vary across the length of the polymer-coated bendable core apparatus 40. For example, the thickness of the polymer coating 400 can be greater over the length of the bendable relief tube 100 compared to the thickness of the polymer coating 400 over the lengths of the top and bottom tube couplings 110, 120 to accommodate for the difference in the outer diameters 102, 112, 122 (FIG. 1). Likewise, the thickness of the polymer coating 400 can be smaller over the lengths of the top and bottom tube couplings 110, 120 compared to the thickness of the polymer coating 400 over the length of the bendable relief tube 100 to accommodate for the difference in the outer diameters 102, 112, 122.

The thickness of the polymer coating 400 corresponds to an outer diameter 410 of the polymer-coated bendable core apparatus 40. The outer diameter 410 is preferably uniform or substantially uniform (e.g., less than or equal to a 5% variation) over the length of the polymer-coated bendable core apparatus polymer-coated bendable core apparatus 40. The outer diameter 410 can be in the range of about 0.125 inches to about 0.5 inches including about 0.25 inches, about 0.375 inches, and any value or range between any two of the foregoing values.

In some embodiments, the polymer coating 400 can be applied thicker than needed. The thickness of the polymer coating 400 can be reduced by placing the polymer-coated bendable core apparatus 40 in a lathe, such as by CNC (computer numerical control) machining, to precisely control the thickness of the polymer coating 400 and the corresponding outer diameter 410 of the polymer-coated bendable core apparatus 40. The polymer coating 400 preferably does not obstruct the continuous channel 150, though in some embodiments a partial obstruction can occur on one or both ends of the continuous channel 150.

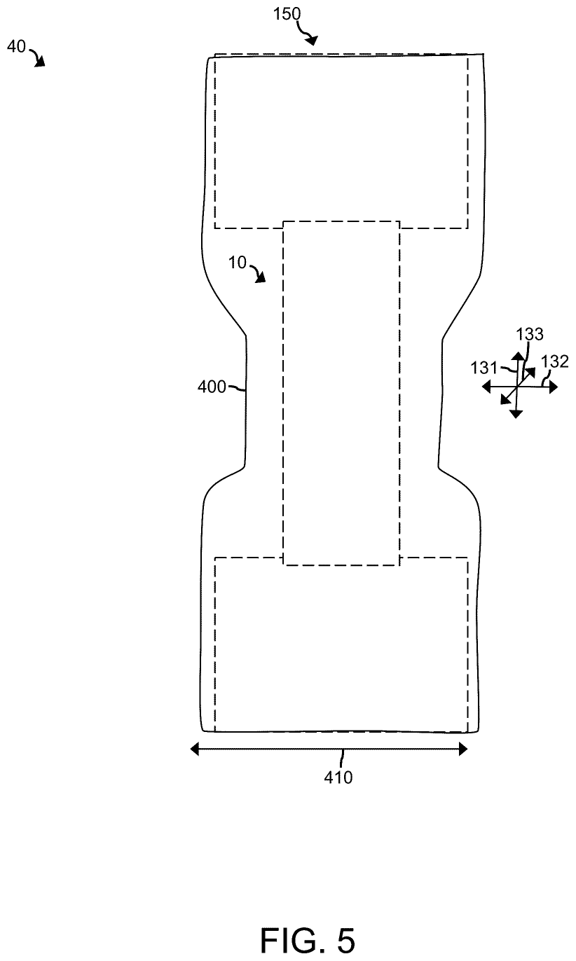

The outer diameter 410 of the polymer-coated bendable core apparatus 40 is equal to and/or corresponds to the inner diameter of a corresponding portion/segment of the golf-club shaft that is being manufactured. In some embodiments, it may be desirable to vary the outer diameter 410 over the length of the polymer-coated bendable core apparatus 40 to produce a golf-club shaft having a corresponding variable inner shaft diameter. A golf-club shaft having a variable inner shaft diameter can have a variable outer shaft diameter that varies according to the variations in the inner shaft diameter. An example of the polymer-coated bendable core apparatus 40 in which the polymer coating 400 provides a variable outer diameter 410 is illustrated in FIG. 5.

Returning to FIG. 3, after the assembled bendable core apparatus is coated with a polymer in step 302, the method 30 proceeds to optional step 303 where the polymer-coated bendable core apparatus can optionally be bent with respect to one or more planes or axes. The polymer-coated bendable core apparatus can be bent in a tube-bending machine such as a CNC tube-bending machine. The polymer-coated bendable core apparatus can be collet gripped while the CNC tube-bending machine bends the polymer-coated bendable core apparatus in the programmed planes/axes. Additionally or alternatively, the polymer-coated bendable core apparatus can be bent using a mold. When the polymer-coated bendable core apparatus is not bent (i.e., optional step 303 is bypassed), the polymer-coated bendable core apparatus does not need to be bendable. For example, the polymer-coated bendable core apparatus can include a non-bendable relief tube instead of bendable relief tube 100.

In an alternative embodiment, the assembled bendable core apparatus can be bent and then coated with a polymer.

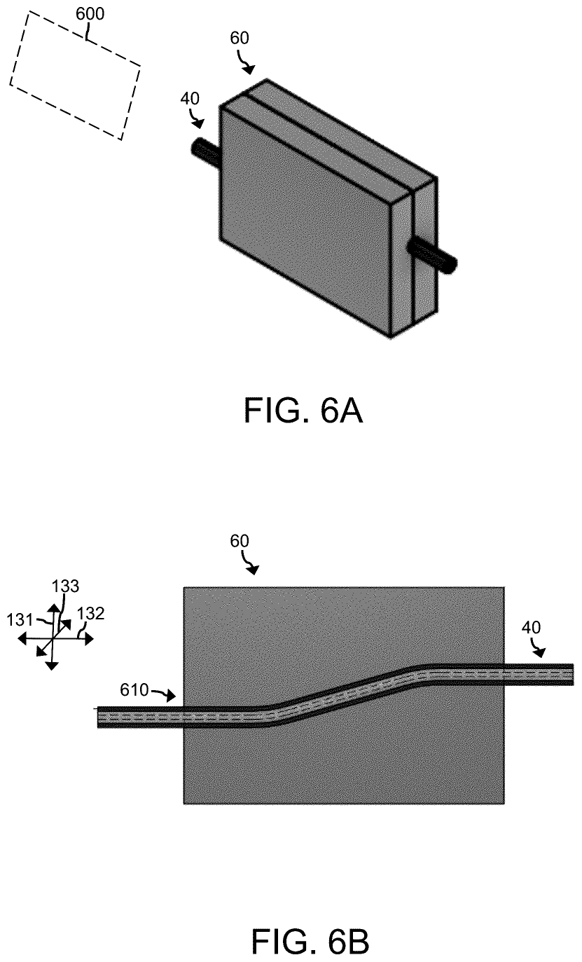

An example of the polymer-coated bendable core apparatus 40 bent in a mold 60 is illustrated in FIGS. 6A and 6B. FIG. 6B is a cross section of the mold 60 formed by plane 600 in FIG. 6A. The mold 60 includes a channel 610 that includes one or more bends to set the bend profile of the polymer-coated bendable core apparatus 40.

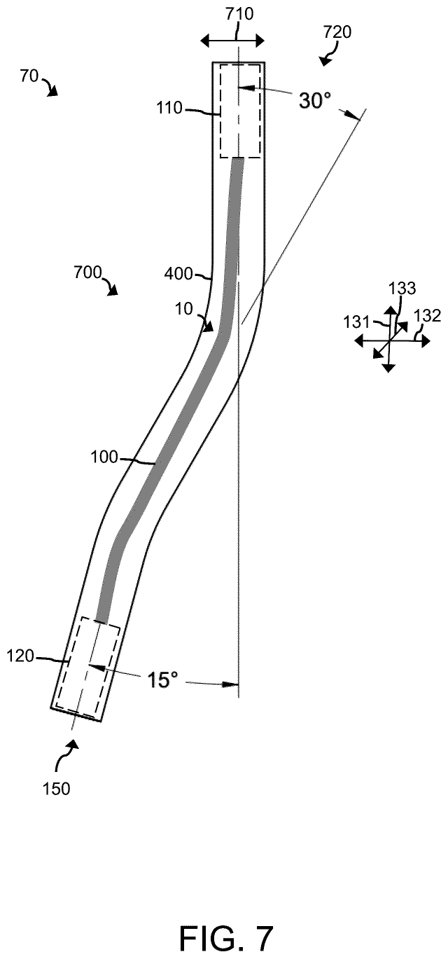

An example of a bent polymer-coated core apparatus 70 is illustrated in FIG. 7. Bends 700 in the bent polymer-coated core apparatus 70 are illustrated with respect to the plane defined by the first and second axes 131, 132. In addition or in the alternative, the bent polymer-coated core apparatus 70 can have bends in the plane defined by the second and third axes 132, 133 and/or in the plane defined by the first and third axes 131, 133. The bent polymer-coated core apparatus 70 has an outer diameter 710 defined by the thickness of the polymer coating 400.

Example bend angles 720 are illustrated with respect to the first axis 131. In addition or in the alternative, bend angles can be formed with respect to the second axis 132 and/or with respect to the third axis 133. The values of the bend angles 720 illustrated in FIG. 7 are provided as examples and are not intended to be limiting.

The bent polymer-coated core apparatus 70 is illustrated as transparent to show the bendable core apparatus 10.

Returning to FIG. 3, after the polymer-coated bendable core apparatus is optionally bent in optional step 303, the method 30 proceeds to step 304 where a removable mandrel is attached to the polymer-coated bendable core apparatus.

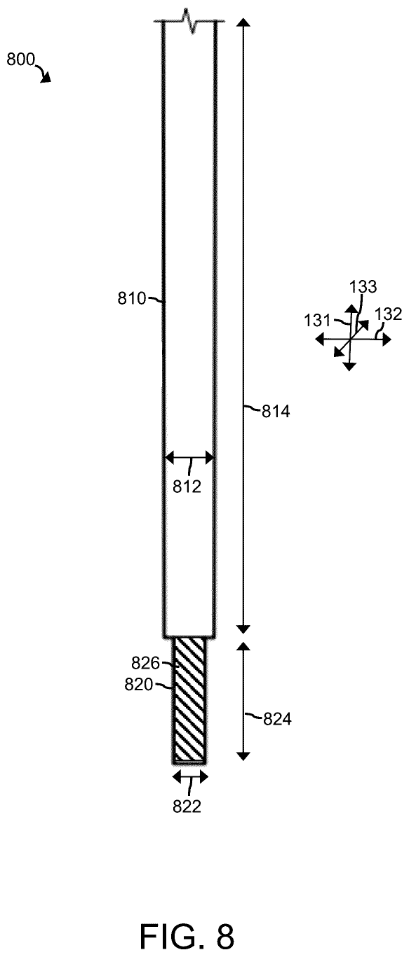

An example of a removable mandrel 800 is illustrated in FIG. 8. The removable mandrel 800 includes a shaft 810 and extends along or parallel to the first axis 131. The shaft 810 can be a tube or a cylinder. The shaft 810 has a diameter 812 (e.g., an outer diameter) that is equal to and/or corresponds to the inner diameter of a corresponding portion/segment of the golf-club shaft that is being manufactured. The diameter 812 can be about 0.35 inches to about 0.75 inches including about 0.5 inches, about 0.6 inches, and any value or range between any two of the foregoing values. The diameter 812 can be measured with respect to the second and/or third axes.

The shaft 810 has a length 814 that corresponds to the length of the corresponding portion/segment of the golf-club shaft that is being manufactured. The length 814 can be about 28 inches to about 36 inches, including about 30 inches, about 32 inches, about 34 inches, and any value or range between any two of the foregoing values. The length 814 can be measured with respect to the first axis 131.

In some embodiments, the diameter 812 can vary with respect to the length 814 of the shaft 810. A varying diameter 812 can be used to vary the inner diameter of the corresponding portion/segment of the golf-club shaft that is being manufactured. Assuming constant thickness of the golf-club shaft material, a variable internal diameter of the golf-club shaft results in a variable outer diameter of the corresponding portion/segment of the golf-club shaft.

A male connector 820 is attached to an end of the shaft 810. The male connector 820 has a diameter 822 (e.g., an outer diameter) of about 0.2 inches to about 0.4 inches, including about 0.25 inches, about 0.3 inches, about 0.35 inches, and any value or range between any two of the foregoing values. The diameter 822 can be measured with respect to the second and/or third axes.

The male connector 820 has a length 824 that can be about 0.75 inches to about 1.25 inches including about 1 inches and any value or range between any two of the foregoing values. The dimensions (e.g., diameter 822 and length 824) of the male connector 820 are configured to allow the male connector 820 to fit into the top channel 115 of the top coupling tube 110 (FIGS. 1, 4).

The male connector 820 and the top coupling tube 110 can include complementary threads that allow the male connector 820 and the top coupling tube 110 to mechanically engage one another in a threaded-fastener connection to form a releasable attachment. For example, the male connector 820 can include external threads 826 (e.g., male threads) and the top coupling tube 110 can include internal threads 160 (e.g., female threads) (FIG. 1) that can be defined in the wall 162 that defines the top channel 115. Additionally or alternatively, the male connector 820 can be attached to top coupling tube 110 (e.g., within the top channel 115) via friction-fit, interference fit, threaded fasteners (e.g., screws and/or bolts), clamps, and/or with a releasable adhesive.

The male connector 820 and/or the top coupling tube 110 (e.g., the wall 162) can be treated with a release agent to ease separation and/or extraction of the male connector 820 from the top coupling tube 110 after thermal processing (e.g., curing). An example of a release agent is a polytetrafluoroethylene (PTFE) release agent such as MS-112/143 available from Miller-Stephenson, Inc., a urethane release agent such as Stoner Urethane Mold Release Agent available from Stoner Molding Solutions, a wax release agent such as ORCA Mold Release Wax (e.g., ORCA Skin) available from Orca Composites, and/or another release agent.

It is noted that the bottom coupling tube 120 can include threads (e.g., threads 160), such as in the wall 162 that defines the bottom channel 125, to attach the bottom coupling tube 120 to another structure such as a golf-club head.

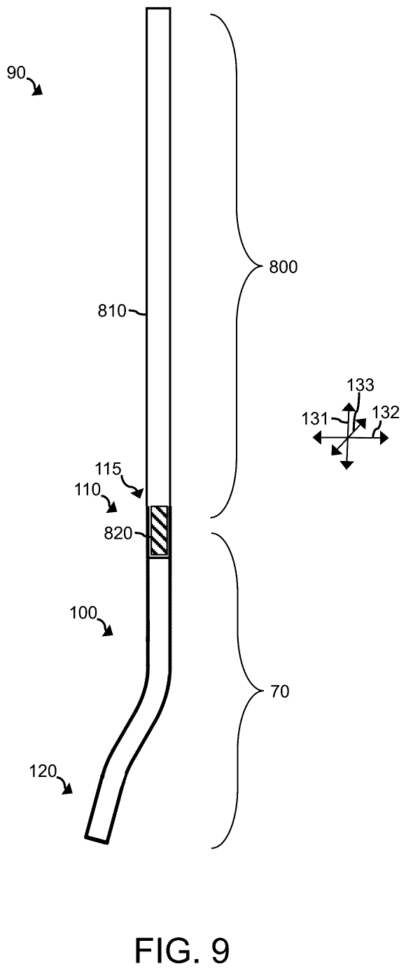

A shaft insert assembly 90 that includes the removable mandrel 800 releasably attached (e.g., via the male connector 820) to the top coupling tube 110 (e.g., in the top channel 115) of the bent polymer-coated core apparatus 70 is illustrated in FIG. 9.

Returning to FIG. 3, after the removable mandrel is attached to the polymer-coated bendable core apparatus in step 304, the method 30 proceeds to step 305 where the shaft insert assembly is covered with a shaft material in step 305.

The shaft material can include a composite material and/or a polymer material.

The shaft insert assembly can be covered with a composite material by wrapping the composite material onto/over the shaft insert assembly. For example, the composite material can be in the form a sheet stock that can be applied from rolls of varying thicknesses and widths in a wrapping fashion. Additionally or alternatively, the composite material be applied by flagging in which small pieces of composite-material filaments are placed along the shaft insert assembly until the desired buildup is achieved. Additionally or alternatively, the composite material be applied by spraying the composite material onto the shaft insert assembly. Additionally or alternatively, the composite material be applied by compression molding the composite material onto the shaft insert assembly. Additional and/or alternative methods can be used to apply the composite material onto the shaft insert assembly as known in the art.

The composite material can comprise or consist of graphite, graphene, fiberglass, a carbon composite (e.g., carbon fiber), compression-molded graphite materials, compression-molded carbon composite materials, and/or another composite material.

Additionally or alternatively, the shaft material can include, in part or in whole, a polymer material such as polyurethane and/or a reinforced polymer material in various percent compositions of reinforcement. The shaft material (e.g., polymer material) can be reinforced (e.g., with respect to the outer shaft layer) with a woven fabric matrix, an additive to the polymer resin, and/or a reinforcement agent.

The composite material and/or polymer material forms the external/outer surface of the golf-club shaft being manufactured.

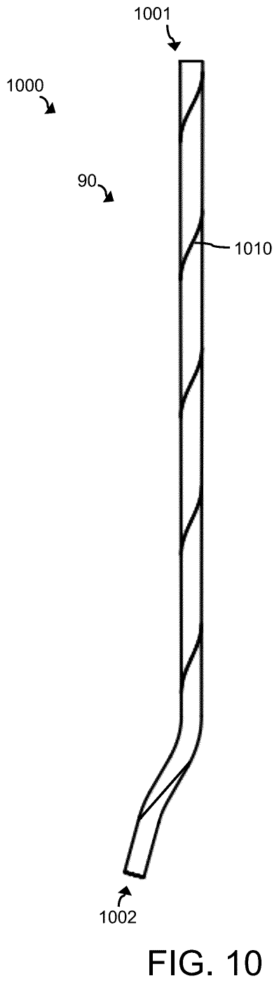

An example of a shaft material covering the shaft insert assembly 1000 is illustrated in FIG. 10. In the shaft insert assembly 1000, a shaft material 1010 covers the length of the shaft insert assembly which can include one or more bends as in shaft insert assembly 90 or which can be straight (e.g., when the shaft insert assembly includes the polymer-coated bendable core apparatus 40). The shaft material 1010 can include a composite material and/or a polymer material, as discussed herein. The shaft material 1010 preferably does not obstruct the opposing ends 1001, 1002 of the shaft insert assembly 1000, though in some embodiments a partial obstruction can occur on one or both ends 1001, 1002.

In step 306, the shaft material is cured while covering the shaft insert assembly. The shaft material can be cured by applying heat (e.g., in a thermochemical process) for a predetermined time at a predetermined temperature to permanently harden the composite or polymer material. The shaft material can be cured in a specialized furnace, such as an autoclave, that can remove any trapped air pockets and/or voids in the composite/polymer material. Additionally or alternatively, a negative (e.g., a vacuum) and/or positive pressure (e.g., higher than ambient pressure) can be applied during curing to remove any trapped air pockets and/or voids in the composite/polymer material.

Additionally or alternatively, the shaft material can be cured in a chemical curing process in which one or more chemicals is/are applied to the shaft material to cause the shaft material to permanently harden.

In step 307, the removable mandrel is removed or detached from the top coupling tube. The removable mandrel can be removed/detached by unscrewing the removable mandrel from the top coupling tube (e.g., by disengaging the complementary threads (e.g., external threads 826 and internal threads 160)), applying a force (e.g., to overcome a friction and/or interreference fit connection), removing any threaded fasteners (e.g., screws and/or bolts), clamps, and/or applying a release agent to the releasable adhesive. The result of step 307 is a raw golf-club shaft.

In optional step 308, the raw golf-club shaft can be finished such as by smoothing the external surface (e.g., by sanding and/or filing), trimming the shaft to the finished-length specifications, applying one or more cosmetic features (e.g., logo(s) and/or coating such as with polyurethane), adding a grip, and/or adding a cap.

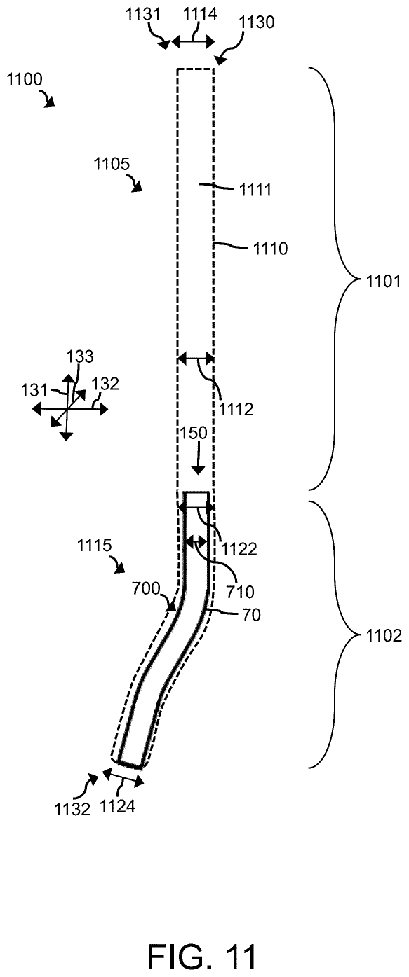

An example of a golf-club shaft 1100 formed according to method 30 is illustrated in FIG. 11. The golf-club shaft 1100 includes a cured shaft material layer 1110 and the bent polymer-coated core apparatus 70. The cured shaft material layer 1110 forms a tube that defines the outer surface 1105 over the length of the golf-club shaft 1100. The tube of the golf-club shaft 1100 can be conceptually divided into upper and lower sections 1101, 1102. The shaft 1100 is shown as transparent for illustration purposes only.

The upper section 1101 corresponds to the portion of the shaft insert assembly 90 that included the removable mandrel 800, which is now removed. The upper section 1101 has a length corresponding and/or substantially equal to the corresponding length of the removable mandrel 800 and has an inner diameter 1112 corresponding and/or substantially equal to the diameter 812 of the removable mandrel 800 (FIG. 8). The upper section 1101 is or generally is in the shape of a hollow tube that extends along or parallel to the first axis. The upper section 1101 has an outer diameter 1114 that corresponds to the amount of the cured shaft material applied. The outer diameter 1114 can be set to a target diameter, which can be included in the golf-club shaft's specifications. The difference between the outer diameter 1114 and the inner diameter 1112 is equal to the thickness of the cured shaft material layer on the upper lower section 1101.

The lower section 1102 corresponds to the portion of the shaft insert assembly 90 that included the bent polymer-coated core apparatus 70. The bent polymer-coated core apparatus 70 remains within the lower section 1102 and becomes a part of the golf-club shaft 1100. The lower section 1102 has a length corresponding and/or substantially equal to the corresponding length of the bent polymer-coated core apparatus 70. In addition, the lower section 1102 has an inner diameter 1122 corresponding and/or substantially equal to the outer diameter 710 of bent polymer-coated core apparatus 70. The shaft material on the lower section 1102 includes one or bends 1115 that conform to one or more respective bends 700 in the bent polymer-coated core apparatus 70. The lower section 1102 has an outer diameter 1124 that corresponds to the amount of the cured shaft material applied. The outer diameter 1124 can be set to a target diameter, which can be included in the golf-club shaft's specifications. The difference between the outer diameter 1124 and the inner diameter 1122 is equal to the thickness of the cured shaft material layer on the lower section 1102.

The outer diameters 1114, 1124 can be the same as each other, substantially the same as each other, or different than each other. One or both outer diameters 1114, 1124 can vary over the length of the respective section 1101, 1102. In addition, the inner diameters 1112, 1122 can be the same as each other, substantially the same as each other, or different than each other.

A continuous channel 1130 extends through opposing ends of the golf-club shaft 1100. The continuous channel 1130 includes a channel 1111 formed in the hollow tube of the upper section 1101 and the continuous channel 150 through the bent polymer-coated core apparatus 70. The golf-club shaft 1100 is preferably open at its opposing ends 1131, 1132, though in some embodiments a partial obstruction from the shaft material can occur on one or both ends 1131, 1132.

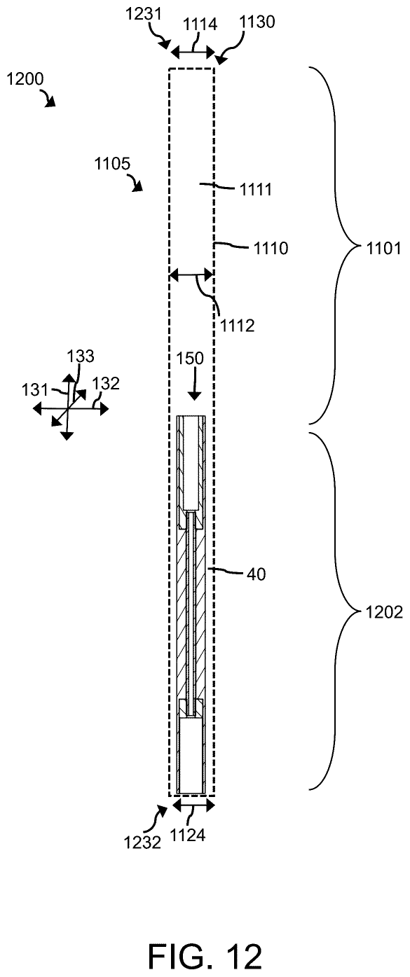

FIG. 12 illustrates another example of a golf-club shaft 1200 that can be formed according to method 30. Golf-club shaft 1200 is the same as golf-club shaft 1100 except that the bent polymer-coated core apparatus 70 in golf-club shaft 1200 is replaced with an unbent (straight) polymer-coated bendable core apparatus 40. The shaft material on the lower section 1202 conforms to the shape and dimensions of the unbent polymer-coated core apparatus 40 such that the lower section 1202. The upper and lower sections 1101, 1202 extend along and/or parallel to the first axis 131. Other than the one or more bends 1115 in the lower section 1102, the lower sections 1102, 1202 are the same.

As in golf-club shaft 1100, a continuous channel 1130 extends through opposing ends of the golf-club shaft 1200. The continuous channel 1130 includes the channel 1111 formed in the hollow tube of the upper section 1101 and the continuous channel 150 through the unbent polymer-coated core apparatus 40. The golf-club shaft 1200 is preferably open at its opposing ends 1231, 1232, though in some embodiments a partial obstruction from the shaft material can occur on one or both ends 1231, 1232.

One or both outer diameters 1114, 1124 can vary over the length of the respective section 1101, 1202.

The bendable relief tube 100 in the unbent (straight) polymer-coated bendable core apparatus 40 (FIG. 4) can optionally be replaced with a non-bendable relief tube in which case the bendable core apparatus 10 can be an unbent core apparatus or a non-bendable core apparatus.

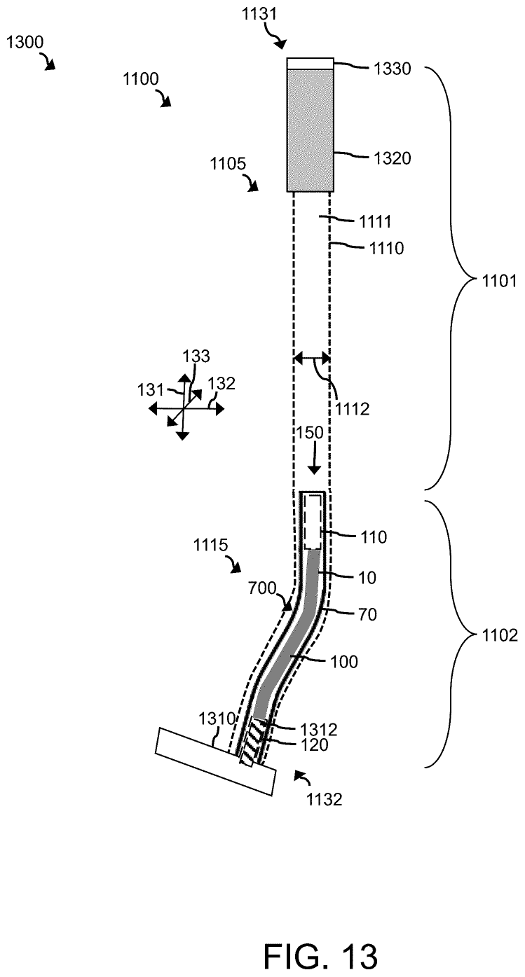

The golf-club shafts described herein can be attached to a golf-club head to form golf clubs. FIG. 13 is an example of a golf club 1300. Golf club 1300 includes a golf-club head 1310 attached to the second end 1132 of the golf-club shaft 1100. For example, the golf-club head 1310 can include a post 1312 that can be attached (e.g., using threads connections, an adhesive, and/or fasteners) in the bottom tube coupling 120 of the bendable core apparatus 10. The golf-club head 1310 can be a putter head, an iron head, or a driver head. A grip 1320 and a cap 1330 can be attached to the first end 1131 of the golf-club shaft 1100.

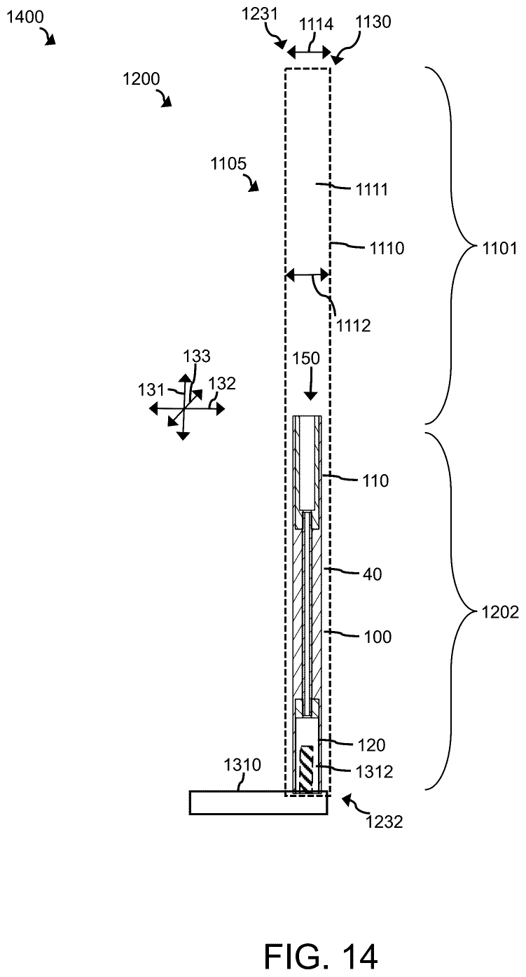

The golf club 1300 can include shaft 1200 instead of shaft 1100. For example, FIG. 14 illustrates a golf club 1400 that includes shaft 1200. Golf club 1400 is otherwise the same as golf club 1300. In some embodiments, the bendable relief tube 100 can be replaced with a non-bendable relief tube in which case the polymer-coated bendable core apparatus 40 is a polymer-coated non-bendable core apparatus.

The polymer-coated bendable core apparatus 40, 70 or the polymer-coated non-bendable core apparatus (in general, polymer-coated core) can be used to mount a golf-club head, such as golf-club head 1310, to the shaft 1100, 1200. When the golf-club head includes a mounting post, either machined or cast into the golf-club head, and the mounting post cannot be adequately mounted to the shaft, polymer-coated core has as an integral feature an internal coupling in the second coupling tube 120 that acts as a mounting surface of sufficient durability to attach the mounting post.

There are two main methods of attachment of a shaft to a golf putter head. The first is where the shaft is fastened (either mechanically or chemically) into a specific hole size in the head of the putter. The second is where a protruding mounting post of varying dimensions and profiles extends out from the putter head which the shaft goes over the top of. Graphite, carbon-based, and composite shafts have been previously impractical to use with mounting posts because these shafts are not durable to withstand the rigors of use in the absence of reinforcement between the shaft and the post. These shafts, under stress, typically fracture and break without reinforcement at the point of connection between the internal putter head post and the externally mounted composite shaft. The bendable core apparatus 10 (or non-bendable core apparatus) with the bottom coupling tube embedded in the mounting area can provide just such reinforcement and attachment point. The bottom coupling tube in the disclosed shaft, in either a straight or bent profile, is configured to go into the head directly or over a protruding mounting post and provides the necessary durability.

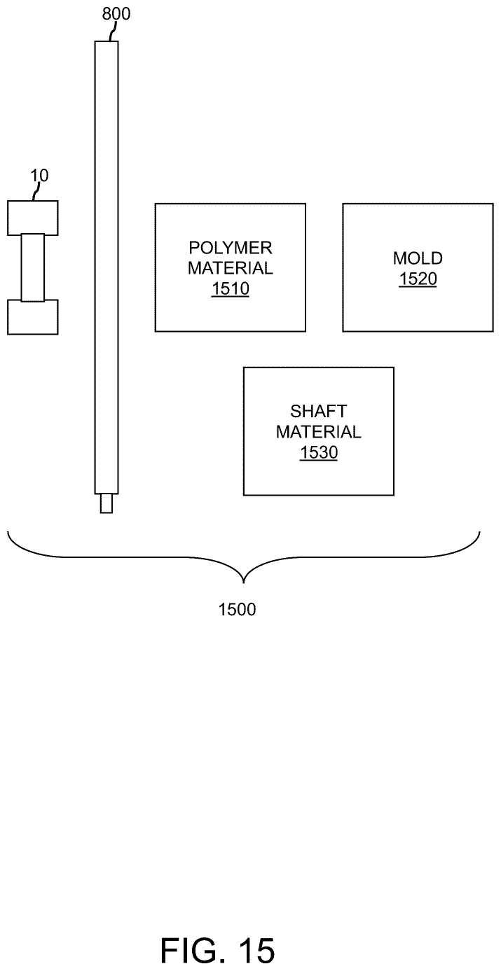

FIG. 15 is a kit 1500 for manufacturing a golf-club shaft according to an embodiment. The kit 1500 includes a bendable core apparatus 10 and a removable mandrel 800. In some embodiments, the kit 1500 can further include polymer material 1510, a mold 1520, and/or shaft material 1530. The polymer material 1510 is configured to be coated onto the bendable core apparatus 10 and includes the same material(s) as the polymer layer 400. The mold 1520 can include one or more channels to bend the bendable core apparatus 10 in one or more directions. The mold 1520 can be the same as or different than mold 60. The shaft material 1530 is configured to be applied to the polymer-coated bendable core apparatus 10 and the removable mandrel 800 in an assembled state to form a shaft-material covering/tube, such as the shaft material 1010 and cured shaft material layer 1110. The shaft material 1530 includes the same materials(s) as shaft material 1010.

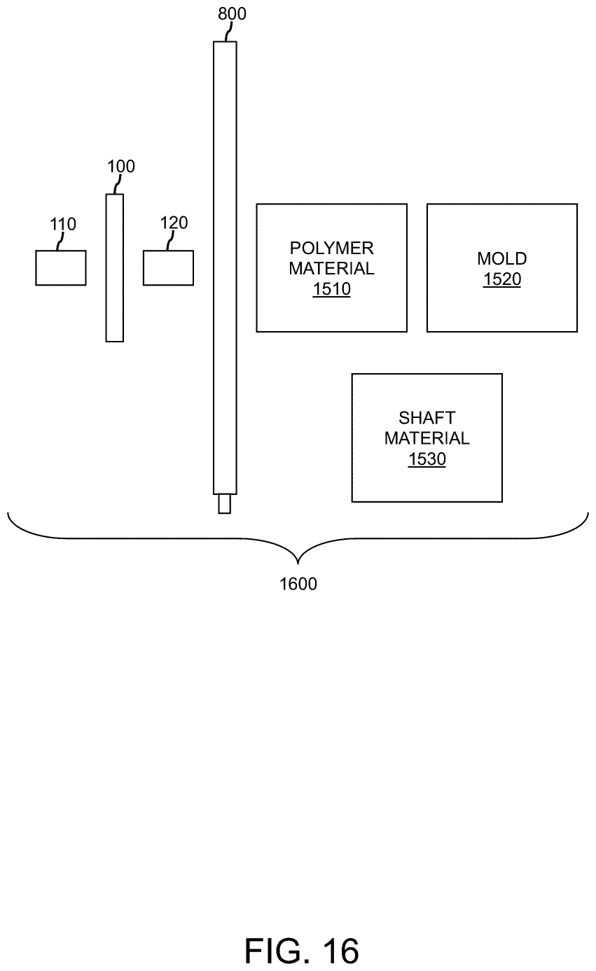

FIG. 16 is a kit 1600 for manufacturing a golf-club shaft according to another embodiment. Kit 1600 is the same as kit 1500 except that kit 1600 includes an unassembled bendable core apparatus. In other words, kit 1600 includes a bendable relief tube 100, a top tube coupling 110, and a bottom tube coupling 120 instead of the bendable core apparatus 10.

In some embodiments, kit 1500 and/or kit 1600 can include a non-bendable relief tube instead of a bendable relief tube 100.

The invention should not be considered limited to the particular embodiments described above, but rather should be understood to cover all aspects of the invention as fairly set out in the attached claims. Various modifications, equivalent processes, as well as numerous structures to which the invention may be applicable, will be apparent to those skilled in the art to which the invention is directed upon review of this disclosure. The claims are intended to cover such modifications and equivalents.

Some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Those skilled in the art would also know and incorporate manufacturing methods, materials and techniques without loss of generality and which are intended to be covered by the scope of the invention. For example, but not by way of limitation, one or more of the present components may be generated in a solid printing apparatus such as a 3D printer which can create the afore mentioned couplings or other details of the invention.

What is claimed is:

1. A bendable core insert configured for manufacturing a golf-club shaft, the bendable core insert comprising:
a bendable relief tube having:
opposing first and second relief-tube ends,
an inner relief-tube diameter that defines a relief-tube channel that extends along a length of the relief tube, and
an outer relief-tube diameter;
a first coupling tube having a first end attached to the first relief-tube end, the first coupling tube having:
an inner first-coupling-tube diameter that defines a first-coupling-tube channel that extends along a length of the first coupling tube, and
an outer first-coupling-tube diameter;
a second coupling tube having a first end attached to the second relief-tube end, the second coupling tube having:
an inner second-coupling-tube diameter that defines a second-coupling-tube channel that extends along a length of the second coupling tube, and
an outer second-coupling-tube diameter,
wherein:
the relief-tube channel, the first-coupling-tube channel, and the second-coupling-tube channel are aligned to form a continuous channel that extends though opposing ends of the bendable core insert,
a length of the bendable core insert corresponds to a length of a corresponding segment of the golf-club shaft, and
the bendable relief tube is configured to be bent in one or more directions to define a bend profile of the corresponding segment of the golf-club shaft.

2. The bendable core insert of claim 1, wherein the outer first-coupling-tube diameter and the outer second-coupling-tube diameter are larger than the outer relief-tube diameter.

3. The bendable core insert of claim 1, wherein:
the bendable relief tube is configured to be bent with respect to a first plane defined by first and second axes, with respect to a second plane defined by the second axis and a third axis, and with respect to a third plane defined by the first and third axes, and
the first, second, and third axes are mutually orthogonal.

4. The bendable core insert of claim 1, wherein the first coupling tube is configured to be releasably attached to a mandrel that corresponds to a straight segment of the golf-club shaft.

5. The bendable core insert of claim 1, wherein the bendable core insert is coated with a polymer material along a length of the bendable core insert, the polymer material having a thickness that defines an outer diameter of the bendable core insert, the outer diameter of the bendable core insert corresponding to an inner diameter of the corresponding segment of the golf-club shaft.

6. The bendable core insert of claim 5, wherein the outer diameter of the bendable core insert is variable with respect to a length of the bendable core insert such that the inner diameter of the corresponding segment of the golf-club shaft is variable.

7. An assembly for manufacturing a golf-club shaft, comprising:
the bendable core insert of claim 5, wherein the corresponding segment is a first of the golf-club shaft;
a mandrel releasably attached to the first coupling tube,
wherein:
a length of the bendable core insert corresponds to a length of the first segment of the golf-club shaft,
a length of the mandrel corresponds to a length of the second segment of the golf-club shaft, and
the bendable relief tube is configured to be bent in one or more directions to define a bend profile of the first segment of the golf-club shaft.

8. The assembly of claim 7, wherein a diameter of the mandrel corresponds to an inner diameter of the second segment of the golf-club shaft.

9. The assembly of claim 7, wherein:
the bendable relief tube is configured to be bent with respect to a first plane defined by first and second axes, with respect to a second plane defined by the second axis and a third axis, and with respect to a third plane defined by the first and third axes,
the first, second, and third axes are mutually orthogonal.

10. A method of manufacturing a golf-club shaft, comprising:
coating a bendable core insert with a polymer material, the bendable core insert comprising:
a bendable relief tube having:
opposing first and second relief-tube ends,
an inner relief-tube diameter that defines a relief-tube channel that extends along a length of the relief tube, and
an outer relief-tube diameter;
a first coupling tube having a first end attached to the first relief-tube end, the first coupling tube having:
an inner first-coupling-tube diameter that defines a first-coupling-tube channel that extends along a length of the first coupling tube, and
an outer first-coupling-tube diameter;
a second coupling tube having a first end attached to the second relief-tube end, the second coupling tube having:
an inner second-coupling-tube diameter that defines a second-coupling-tube channel that extends along a length of the second coupling tube, and
an outer second-coupling-tube diameter,
wherein:
the relief-tube channel, the first-coupling-tube channel, and the second-coupling-tube channel are aligned to form a continuous channel that extends though opposing ends of the bendable core insert, and
a length of the bendable core insert corresponds to a length of a first segment of the golf-club shaft;
bending the bendable relief tube in one or more directions to define a bend profile of the first segment of the golf-club shaft;
coating the bendable core insert with a first polymer material along a length of the bendable core insert, the first polymer material having a thickness that defines an outer diameter of the bendable core insert, the outer diameter of the bendable core insert corresponding to an inner diameter of the first segment of the golf-club shaft;
attaching a removable mandrel to a second end of the first coupling tube to form a shaft insert assembly, the removable mandrel having:
a length that corresponds to a length of a second segment of the golf-club shaft, and
a diameter that corresponds to an inner diameter of the second segment of the golf-club shaft;
covering the shaft insert assembly with a shaft material that includes a composite material and/or a second polymer material to form a covered shaft insert assembly;
curing the covered shaft insert assembly; and
after curing, removing the removable mandrel from the second end of the first coupling tube to form the golf-club shaft, the golf-club shaft including the bendable core insert.

11. The method of claim 10, wherein the second segment of the golf-club shaft comprises a tube formed by the shaft material.

12. The method of claim 10, wherein the shaft material conforms to one or more bends in the bendable relief tube to form the bend profile in the first segment of the golf-club shaft.

13. The method of claim 12, the one or more bends include:
a first bend with respect to a first plane defined by first and second axes, and
a second bend to a second plane defined by the second axis and a third axis,
wherein the first, second, and third axes are mutually orthogonal.

14. The method of claim 13, the one or more bends include a third bend with respect to a third plane defined by first and third axes.

15. A golf-club shaft comprising:
a shaft tube formed of a shaft material that includes a composite material and/or a polymer material, the tube having a channel and first and second sections; and
a polymer-coated core insert in the channel of the first section, the polymer-coated core insert extending along a length of the first segment, wherein the second section is hollow.

16. The golf-club shaft of claim 15, wherein the polymer-coated core insert comprises:
a relief tube;
a first coupling tube having a first end attached to a first relief-tube end;
a second coupling tube having a first end attached to a second relief-tube end; and
a polymer material coating the bendable core insert along a length of the core insert, the polymer material having a thickness that defines an outer diameter of the bendable core insert, the outer diameter of the bendable core insert defining an inner diameter of the first section of the golf-club shaft.

17. The golf-club shaft of claim 16, wherein:
the relief tube is bent in one or more directions, and
the first section has a bend profile that conforms to one or more bends in the relief tube.

18. The golf-club shaft of claim 16, wherein the second coupling tube has a second end that is configured to be attached to a golf-club head.

19. The golf-club shaft of claim 16, wherein the shaft material includes the composite material, the composite material comprising graphite, graphene, fiberglass, and/or carbon fiber.

20. A golf club comprising:
the golf-club shaft of claim 16; and
a golf-club head attached to the first section of the shaft tube.

21. A kit for manufacturing a golf-club shaft, comprising:
a bendable relief tube having:
opposing first and second relief-tube ends,
an inner relief-tube diameter that defines a relief-tube channel that extends along a length of the relief tube, and
an outer relief-tube diameter;
a first coupling tube having a first end configured to be attached to the first relief-tube end, the first coupling tube having:
an inner first-coupling-tube diameter that defines a first-coupling-tube channel that extends along a length of the first coupling tube, and
an outer first-coupling-tube diameter;
a second coupling tube having a first end configured to be attached to the second relief-tube end, the second coupling tube having:
an inner second-coupling-tube diameter that defines a second-coupling-tube channel that extends along a length of the second coupling tube, and
an outer second-coupling-tube diameter; and
a mandrel releasably attached to the first coupling tube,
wherein when the first coupling tube is attached to the first relief the first relief-tube end and the second coupling tube is attached to the second relief-tube end, the relief-tube channel, the first-coupling-tube channel, and the second-coupling-tube channel are configured to be aligned to form a continuous channel.

22. The kit of claim 21, wherein:
the first coupling tube is attached to the first relief the first relief-tube end and the second coupling tube is attached to the second relief-tube end to form an assembled bendable core insert,
the continuous channel extends though opposing ends of the assembled bendable core insert,
a length of the assembled bendable core insert corresponds to a length of a corresponding segment of the golf-club shaft, and
the assembled bendable relief tube is configured to be bent in one or more directions to define a bend profile of the corresponding segment of the golf-club shaft.
